(19) United States
(12) Patent Application Publication
(10) Pub. No.: US 2024/0276039 A1
(43) Pub. Date: Aug. 15, 2024

(54) METHOD FOR SUPERVISING A MULTIMEDIA STREAM READING TERMINAL WITH TIMING OF THE TRANSMISSION OF THE TRACKING DATA

(71) Applicant: Orange, Issy-Les-Moulineaux (FR)

(72) Inventors: Mathieu RIVOALEN, Chatillon Cedex (FR); Hervé MARCHAND, Chatillon Cedex (FR)

(21) Appl. No.: 18/440,628

(22) Filed: Feb. 13, 2024

(30) Foreign Application Priority Data
Feb. 13, 2023 (FR) 2301316

(51) Int. Cl. H04N 21/24; H04N 21/61

(52) U.S. Cl. CPC H04N 21/24; H04N 21/6131

(57) ABSTRACT

A method for supervising a multimedia stream reading terminal through a telecommunication network. The method includes: collecting tracking data intended for at least one tracking server connected to the telecommunication network, storing these tracking data in a buffer memory of the reading terminal, checking a resource load criterion of the reading terminal, and transmitting at least a part of the tracking data to the tracking server or servers when this criterion is met.

### CROSS-REFERENCE TO RELATED APPLICATIONS

This application claims foreign priority to French Patent Application No. FR 2301316, entitled “METHOD FOR SUPERVISING A MULTIMEDIA STREAM READING TERMINAL WITH TIMING OF THE TRANSMISSION OF THE TRACKING DATA” and filed Feb. 13, 2023, the content of which is incorporated by reference herein in its entirety.

### BACKGROUND

### Field

This development relates to the field of multimedia stream reader terminals. It applies in particular to terminals installed in the homes of users to allow them to view video content streamed by content servers, such as television channels, on-demand video etc.

It more specifically relates to the remote supervision of these terminals and of the application or applications installed on these terminals, by means of tracking data transmitted by the applications and addressed to the tracking servers.

### Prior Art

Specifically, any computer product must nowadays be supervised via uploads of user or technical data to improve its durability and its efficiency. An application providing a service to a user gives rise to the uploading of as many tracking data as there are functionalities. However, equipment such as multimedia stream reading terminals have a growing number of functionalities.

The uploading of tracking data requires the transmission of requests, generally according to the HTTP protocol, to several tracking servers. These transmissions impinge on the resources of the reading terminal, whether it is the terminal's own resources (information-processing circuits, CPU etc.) or network connection resources (bandwidth etc.)

There is thus a need for improving the current provisions of the prior art.

### SUMMARY

The development has the aim of reducing the impact of the uploading of the tracking data on user experience. In particular, it has the aim of minimizing the impact on the computational resources of the terminals and on the bandwidth of the link from the terminals to the access network.

For these purposes, according to a first aspect, this development can be implemented by a method for supervising a multimedia stream reading terminal, through a telecommunication network, including steps of:
collecting tracking data intended for at least one tracking server connected to said telecommunication network,
storing said tracking data in a buffer memory of said reading terminal,
checking a load criterion of the resources of said reading terminal,
transmitting at least a part of said tracking data to said at least one tracking server when said criterion is met.

According to preferred embodiments, the development comprises one or more of the following features which can be used separately or in partial combination with one another or in total combination with one another:
data of a first type (for example technical tracking data) and data of a second type (for example usage tracking data) are stored separately, and said data of the first type are transmitted as a priority when said criterion is met. This in particular makes it possible, firstly, to refine the management of different types of tracking data, but also to allow faster intervention in relation to a type of tracking data (typically technical tracking data, without the usage tracking data penalizing this technical tracking by occupying too much of the bandwidth).
the data of the first type (for example technical tracking data) are stored and the data of the second type (for example user tracking data) are stored in two separate buffer memories. One particular advantage of this embodiment is that it refines the management of the different types of data and, where applicable, implements different policies for managing buffer memories according to the type of tracking data.
said resources comprise a load of the processing circuits of said terminal. This in particular makes it possible to take into account the fact that the transmission of the tracking data requires a computational processing which can penalize the other uses of the processing circuits, particularly for the streaming of multimedia content.
said resources comprise a bandwidth to said telecommunication network. One particular advantage of this embodiment is that it takes into account the use of the bandwidth by the uploading of the usage data which can impinge on the bandwidth for the reception of the multimedia streams
said load criterion comprises the maintaining of a load below a given threshold for a given period. One particular advantage of this embodiment is that it guards against instantaneous fluctuations in load.
the supervising method further includes steps of supervising the location of a pointer in a human-machine interface of said reading terminal, and of triggering the transmission of at least a part of said tracking data to said at east one tracking server when said location is in a given area. The given area can for example correspond to an area around an icon or menu, the selection of which causes the closing of the application. One advantage of this implementation is that it avoids too many data being lost due to this closing.

Another aspect of the development relates to a multimedia stream reading terminal comprising at least one interface to a telecommunication network and comprising a processor configured to carry out the following steps:
collecting tracking data intended for at least one tracking server connected to said telecommunication network,
storing said tracking data in a buffer memory of said reading terminal,
checking a resource load criterion of said reading terminal,
transmitting at least a part of said tracking data to said at least one tracking server when said criterion is met.

Another aspect of the development relates to a computer program able to be implemented on a multimedia stream reading terminal, the program comprising code instructions which, when it is executed by a processor, carries out the steps of the method as previously defined.

Another aspect of the development relates to a data medium on which has been stored at least a series of program code instructions for executing a method as previously defined.

Other features and advantages of the development will become apparent on reading the following description of a preferred embodiment of the development, given by way of non-limiting example and with reference to the appended drawings.

### BRIEF DESCRIPTION OF THE DRAWINGS

The appended drawings illustrate the development:

FIG. 1 illustrates a context of implementation of a method for supervising a multimedia stream reading terminal,

FIG. 2 schematically represents a functional architecture of a multimedia stream reading terminal;

FIG. 3 illustrates an example of a graphic interface which can be displayed by a screen associated with a multimedia stream reading terminal;

FIGS. 4a to 4f illustrate an example of routing, ordered in time, of a user through the human-machine interface displayed by a reading terminal.

### DETAILED DESCRIPTION OF CERTAIN ILLUSTRATIVE EMBODIMENTS

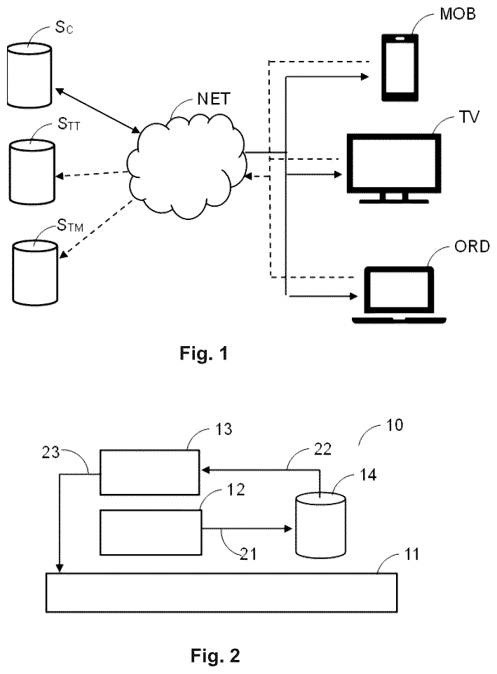

FIG. 1 illustrates a context of implementation of a method for supervising a multimedia stream reading terminal.

It is applicable to different types of multimedia stream reading terminal, such as in particular a mobile terminal MOB, a connected television TV or a computer ORD.

The mobile terminal MOB is typically a smartphone or a digital tablet, suitable for receiving multimedia streams and producing them on an interface of the terminal or connected to said terminal.

The television TV can be natively connected or be so by the intermediary of an associated device such as for example an HDMI key connected to the television.

One example of an external device communicating with a television TV is Chromecast. The Chromecast is a real-time multimedia stream reading device (multimedia gateway), developed and marketed by Google. The device is connected to an HDMI port of a television and communicates, by Wi-Fi connection, with another device connected to the Internet (computer, smartphone, tablet etc.), in order to display on the television the multimedia content received from an application compatible with the Google Cast technology, from the Google Chrome browser installed on a computer, or from certain Android devices.

In the latter case, the multimedia stream, or content, reading terminal can be this associated device.

Multimedia streams typically comprise video or audio-video streams (or content). They can also be audio streams (music, radio programs etc.), or interactive content (including games).

The terminals can receive these multimedia streams from a content server S_{C} through a telecommunication network NET to which they are connected, in a manner known per se. This telecommunication network can be composed of several interconnected networks, particularly of a local network, of an access network and of an extended “Internet” type network.

The local network can be a network installed at the home of a user, allowing him to connect different terminals to an access point that forms a gateway to an access network to the wider network. Such a local network can be of different technologies, for example Wi-Fi, Ethernet™, etc.

According to other embodiments, the content server S_{C} can be accessible directly by the local network of the user.

In the example of FIG. 1, the solid arrows show the exchanges between the terminals MOB, TV, ORD and the content server S_{C}. These exchanges comprise the transmission of a multimedia content, or stream, from the content server S_{C} to the terminals. They also comprise command messages transmitted by these terminals to the content server. These command messages are in particular intended to allow the choice of a multimedia stream.

Moreover, the terminals MOB, TV, ORD transmit tracking, or tracing data, to one or more tracking servers STT, STM. In the example of FIG. 1, these transmissions are represented by the dotted arrows.

Specifically, tracking, or tracing, is commonly put in place to remotely supervise the behavior of equipment or software applications. This tracking can concern different purposes, in particular:
the uploading of usage data, in order to know, statistically, the behavior of the uses of the equipment and/or of the software application and where applicable to influence the development of later versions;
the uploading of technical data, used to obtain the behavior, from a technical point of view, of the equipment and/or of the software application. The aim here is thus to identify errors, disclose performance problems, etc.

In general, data of different types can thus be taken into consideration and be the subject of separate processing. In particular, a first type corresponds to technical tracking data and a second type to usage tracking data.

In general, usage tracking can be intended for a marketing service in charge of designing new functionalities or new developments to be implemented, while technical tracking can be intended for a technical department for maintenance of the current version of the device or of the software application or to correct certain problems in a later version.

In the example of the figure, two separate tracking servers for these two types of data are considered.

It is however possible to group these two types of tracking data onto a single tracking server. It is also possible to consider other types of tracking data and other tracking servers. As will become apparent, the supervising method is independent of the type and number of the tracking data and of the tracking servers, STT, STM.

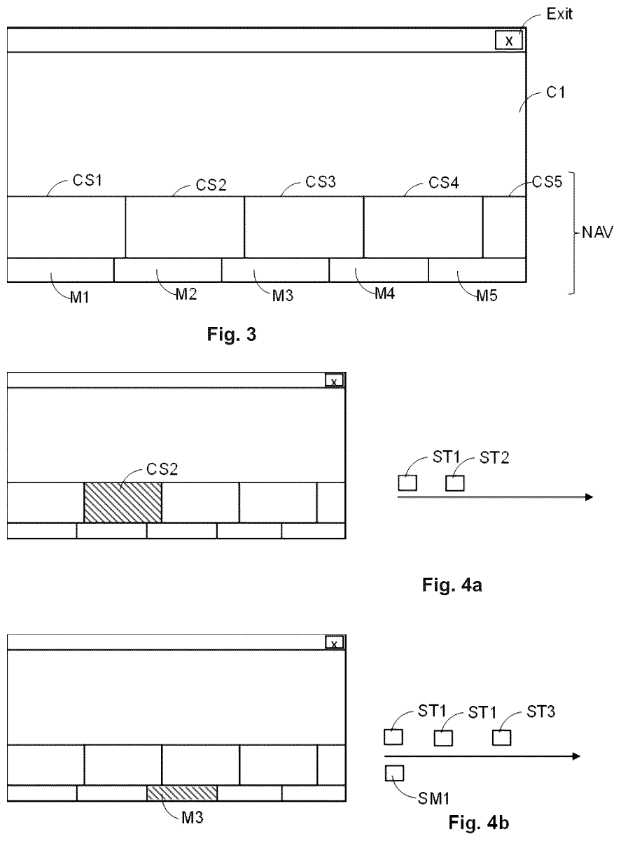

FIG. 2 schematically represents a functional architecture of a multimedia stream reading terminal 10.

A multimedia stream reading terminal 10 is a device for processing information.

Such an information-processing device typically comprises one (or more) microprocessors, one (or more) memories and electrical circuits allowing their connection or performing other functionalities. In particular, such an information-processing device can include specific circuits suitable for connection to the telecommunication networks NET (Wi-Fi, Ethernet™ interfaces etc.), for on-the-fly decoding of video streams, etc.

These aspects being well-known to those skilled in the art, they will not be further described in this application.

Software programs are executed on this hardware architecture to allow it to fulfil the expected functions.

From a functional point of view, these software programs comprise an operating system 11 and software applications.

These software applications can be of various kinds. They comprise software applications adapted to the functionalities of a video stream reading terminal.

FIG. 2 shows two functional blocks 12, 13. These functional blocks can be independent applications or modules (or a function) of one and the same application.

Provision can be made for a functional block 12 to carry out the tracking, or tracing, of the activity on the terminal 10.

This functional block 12 can be, or be part of, the application in charge of reading the multimedia streams. It can also be separate and collaborate with this application in order to possess the necessary information to perform its tracking role.

The functional block 12 can be suitable for collecting information allowing it to define tracking data.

The collecting of information can be triggered at each action, or command, of the user by means of the human-machine interface of the terminal 10. This command can consist in a selection, or “click”, of an icon but also simply a mouseover, according to the arrangements specific to the interface.

The collecting of information can be triggered periodically or by other events not depending on the actions of the user.

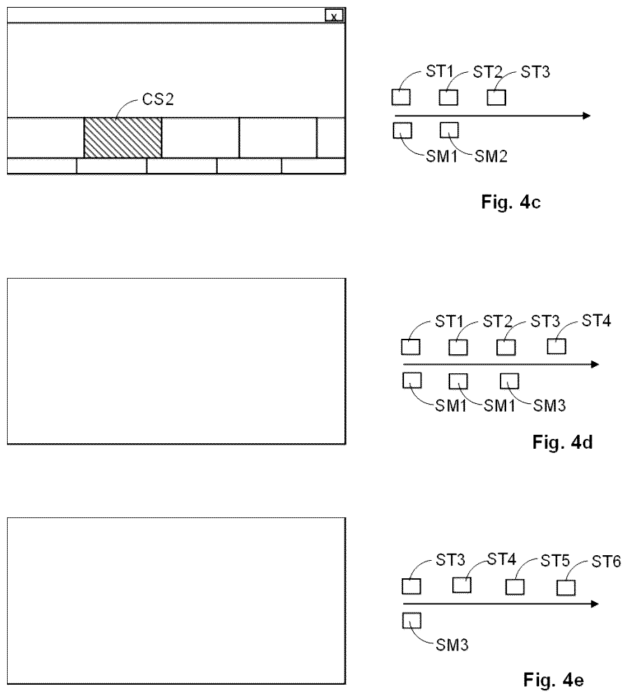

FIG. 3 illustrates an example of a graphic interface which can be displayed by a screen associated with the multimedia stream reading terminal 10.

This graphic interface can display, concurrently, a video content, or stream, in an area C1, and a navigation area NAV allowing interactions with the terminal user and in particular allowing the changing of the video stream to be displayed in the area C1.

The navigation area NAV includes a set of areas CS1, CS2, CS3, CS4, CS5 intended for the display of secondary video streams or content. This secondary content can for example be other television channels.

The selection of a secondary area can trigger the display of the secondary video content in the main area C1. The content previously displayed in this main area C1 can then be displayed in a secondary area. The user can thus switch from one video content to another video by means of this graphic interface.

The navigation area can also include menus M1, M2, M3, M4, M5, allowing other navigation options, for example changing multimedia content source: it can for example be about connecting to another content server S_{C}, collecting multimedia content stored locally, etc.

The graphic interface can include other elements not shown in the figure: menus, scrolling or otherwise, accessible for example by means of the selection of a menu M1, M2, ML3, M4, M5, or a key of a remote control associated with the terminal 10, etc. These elements can make it possible to access yet more options, for example all the television channels available.

The tracking typically has the aim of knowing the behavior of the user with this human-machine interface (usage tracking) and the behavior of the software application via the choices made by the user (technical tracking).

In fact, different types of tracking can be carried out, and different tracking policies can also be implemented. The supervising method for which provision is made can be adapted to different types of tracking and to various tracking policies.

Returning to FIG. 2, the functional block 12 can collect tracking information when an event occurs. This event can be a selection, or where applicable, a simple mouseover by means of a pointing device (such as a remote control) of an element CS1, CS2, CS3, CS4, CS5, M1, M2, M3, M4, M5 can trigger the collection of tracking information.

The functional block 12 can then store the tracking data 21 in a buffer memory 14. These tracking data may correspond to all or part of the tracking information, within which a selection or a preprocessing can be carried out. Furthermore, the tracking data may contain data added by the functional block 12 such as in particular a timestamp.

The tracking data are stored by block or record: each record in the buffer memory corresponds to a sequence of unit data such as a timestamp, the type of event that triggered the generation, context data (state of the interface, identifier of the area selected by the user or under focus, etc.), etc.

These tracking data 21 can be intended for different tracking servers, STT, STM as known to those skilled in the art.

In an exemplary embodiment, provision can be made for separately storing usage tracking data and technical tracking data. The usage tracking data are intended to be transmitted to a usage tracking server STM, and the technical tracking data are intended for a technical tracking server STT.

This separation can be carried out by assigning an appropriate value of a field of the record of the tracking data in the buffer memory 14. It can also be carried out by storing the tracking data in separate parts of the buffer memory 14, or else in two separate buffer memories.

These tracking data 21 are stored and are not intended to be transmitted immediately to the tracking servers. Specifically, according to the proposed supervising method, the transmission of the tracking data to the tracking servers is only triggered at timely moments corresponding to a load state of the multimedia stream reading terminal 10.

A functional block 13 is adapted to check a resource load criterion of the terminal 10.

This check can be periodic, according to a previously defined periodicity. It can also be triggered by certain events occurring on the terminal 10.

The resources of the terminal are in particular a load of the data processing circuits of the terminal 10 and in particular of the main circuit of CPU (Computer Processing Unit), and the bandwidth to the telecommunication network NET. In particular, the bandwidth to the telecommunication network can be the bandwidth of the uplink, i.e. corresponding to the transmission of information from the terminal 10 to the equipment of the telecommunication network 10.

The exposed supervising method also comprises the transmission of at least a part of these tracking data to the tracking server or servers STT, STM when the proposed criterion is met.

The transmission of tracking data is therefore subordinate to the meeting of a particular criterion related to the resource load of the reading terminal 10.

According to an embodiment, the transmission of tracking data is subordinate to the state of the load of the processing circuits of the reading terminal 10 and to the bandwidth to the telecommunication network. As previously indicated, only one of these loads can be taken into consideration. Provision can also be made for taking into account other loads that might affect the performance of the reading terminal 10.

The criterion can be based on a stabilization of a load state below a given threshold. Such a criterion is met when the load under consideration (network bandwidth, CPU load, or other) is below this threshold for a given time period. This mechanism makes it possible to guard against instantaneous load fluctuations, inherent to this type of reading terminal.

In this way, the supervising method makes it possible to transmit tracking data only at the timely moments when their transmission has minimal impact on the performance of the reading terminal, and hence the experience of the user of this reading terminal.

In particular, it avoids the transmission of the tracking data from affecting the bandwidth of the connection with the telecommunication network and therefore the receiving of the multimedia streams.

It also avoids this transmission affecting navigation through the graphic interface (network overload, increase in latency etc.) As seen previously, each action of the user can generate one or more tracking data records (typically technical tracking data and usage tracking data). Thus, when the user navigates to search for a particular multimedia content, a high volume of tracking data can thus be generated. Hence, the storage in the buffer memory and the transmission to the tracking servers at timely moments makes it possible to avoid this navigation from being excessively slowed down by the on-the-fly transmission of these very numerous tracking data.

In general, any reduction in the ability of the reading terminal to provide the planned services to the user is to be avoided or limited.

When the previously determined criterion is met, the functional block 13 can collect tracking data 22 stored in the buffer memory 14 (or the buffer memories), in order to transmit them, 22, to the tracking servers through the telecommunication network. In the illustrative example of FIG. 2, the transmission of these tracking data 22 is done via the operating system 11 which handles the protocol stack and the interfaces toward this telecommunication network. The transmission is done data block by data block, since each data block forms a consistent set including unit data relevant to one and the same event.

According to an embodiment, only a part of the tracking data is transmitted at each check of the load criterion (i.e. a number of blocks, or records, of the tracking data).

According to an embodiment, a predefined number of tracking data can be transmitted each time. For example, each time the criterion is checked and is met, the functional block 13 transmits two technical tracking data and two usage tracking data.

According to an embodiment, this number can depend on the resource load. Thus, the lower this load, the more tracking data the functional block 13 can transmit.

According to an embodiment, the usage tracking data and the technical tracking data are stored separately and the technical tracking data are transmitted as a priority, when the criterion is met. This is because the technical tracking data can be considered to require a more short-term reaction, if they reflect a malfunction of the application and/or of the reading terminal.

According to an embodiment, one may evaluate the number of records of technical tracking data and usage tracking data and prioritize those stored in the greatest number in the buffer memory 14.

It therefore appears that different strategies can be deployed to select the tracking data to be transmitted when the load criterion is checked and met.

The tracking data may be stored in the buffer memory in the form of a queue. The tracking data selected for transmission may be chosen according to their timestamp, such that the oldest are selected preferentially (“FIFO” for “First In, First Out”).

The transmission of the tracking data to the tracking server or servers STT, STM may comprise the formatting of messages in the appropriate format for their transmission via the telecommunication network NET.

Typically, these messages are requests compliant with the HTTP (Hypertext Transfer Protocol) protocol. This protocol is well-known to those skilled in the art and specified in its current version in RFC 7230 to 7237 of the IETF (Internet Engineering Task Force).

Usage tracking data can be transmitted by the “GET” method of the HTTP protocol.

With the GET method, the data to be sent to the server are described directly in the URL. A GET request contains a set of parameters separated by an escape character “&”. These parameters may form the whole of the tracking data of a record 21 in the buffer memory. These parameters are typically in the “parameter type=parameter value” format.

Thus, a simplified example of such a request can be GET https://analyse.exemple.com/collect?t=event&ec=homepage &ea=live

This request includes, first, the address of the usage tracking server, here given by its URL: analyse.exemple.com. It also comprises parameters indicating that the user has put the focus on “all live channels”) on the homepage.

The technical tracking data can be transmitted by a “POST” method.

The POST method describes the URL parameters in the HTTP request for the server, within a message body contained between escape characters “{” and “}”.

A simplified example of a message transmitting technical tracking data can be of type:
POST https://datacollector.exemple.com/track
{“version”:“a.b.c”,“timestamp”: 1667474446560, “eventType”: “info”, “device”: {“id”:“e id123445”,“version”:“2.1.3.456(124ezfzdczdze22)”, “model”: “Produit1”, “mac”: “aa:bb:cc:dd:e e:ff”},“application”: {“name”:“appname”,“version”: “1.2.3(080223)” },“info”: {“do”: “tech”,“me “:”conf“,”de“: {”cf“:[{“file”: “homepage.json”, “version”: “1.0.0” } ]} } }

The part ‘ “: {”cf“:[{“file”:“homepage.json” ’ indicates that the human-machine interface has displayed the homepage. The other parameters indicate the type of terminal, its version, the name and version of the application, the timestamp of the tracking data etc.

These examples are deliberately simplified, since many other parameters can be stored by the functional block 12 then transmitted by the functional block 13, in order to capture the context related to the tracking as well as possible.

Specifically, whether it is for usage tracking data or technical tracking data, it is important for tracking servers to possess a large number of context data to be able to exploit these uploads as well as possible.

It is therefore clear that the tracking data transmitted to the tracking servers may account for considerable volumes, such that the deferral of these transmissions to timely moments offers a significant technical advantage for the resource load of the terminal (network and computational resources).

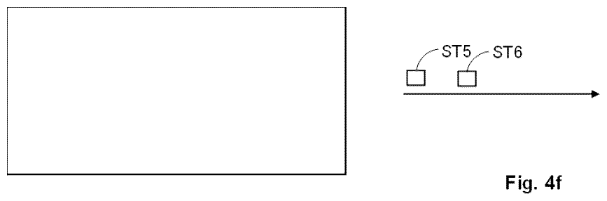

FIGS. 4a to 4f illustrate an example of a path, ordered in time, of a user through the human-machine interface displayed by the reading terminal 10. The interface of this example is similar to that of the example of FIG. 3.

In these figures, the technical and usage tracking data stored in the buffer memory are shown opposite each state of the interface. The arrow illustrates the direction of time and therefore the order in which the tracking data are inserted into the memory. It is considered that these data are inserted and consumed in the form of a queue.

In an initial state of FIG. 4a, the focus of the interface is on the secondary content CS2, which generates two blocks of technical tracking data ST1, ST2.

In FIG. 4b, the user has moved the focus onto the menu M3. This generates a new block ST3 of technical tracking data, and a new block SM1 of technical tracking data. As the user is navigating, the load criterion is not met and the tracking data are not transmitted.

In FIG. 4c, the user has moved the focus onto the area CS2 corresponding to a secondary video content. This generates a new block SM2 of usage tracking data. As the user is navigating, the load criterion is not met and the tracking data are not transmitted.

In FIG. 4d, the user has selected this secondary video content and the display comprises only a single area in which this content has become the main content. This, typically, is a mode in which the user is watching a video program without navigating through the interface. This switch causes the generation of a new block ST4 of technical tracking data, and of a new block SM3 of usage tracking data. The user has stopped navigating but the resource load of the terminal has not yet stabilized. The tracking data are therefore not transmitted.

In FIG. 4c, the user continues to watch the video program, and the interface remains identical. New blocks of technical tracking data ST5, ST6 are generated, for example generated periodically. Since the resource load has stabilized, blocks of tracking data, SM1, SM2, ST1, ST2 are transmitted (and therefore removed from the buffer memory shown in the figure).

In FIG. 4f, the interface remains identical. A new block ST7 of technical tracking data is generated. The blocks SM3, ST3, ST4 of tracking data are transmitted.

Note that in the stabilized load state of the resources, the queue is consumed.

The tracking data are transmitted to the appropriate tracking servers at the timely moment when the resource load is low and stabilized. Insofar as the tracking does not require real-time processing, this transmission delay (latency) does not pose any particular problem. Furthermore, the tracking data can be timestamped, which makes their value independent of the moment of their actual transmission by the reading terminal 10.

According to an embodiment of the development, the tracking data can also be transmitted when the user manifests the intention to close the application.

To do this, the application can be adapted to
supervise the location of a pointer in the human-machine interface associated with the reading terminal, and
trigger the transmission of at least a part of said tracking data to the at least one tracking server when this location is in a given area.

The given area corresponds to an area around an icon or menu, the selection of which causes the closing of the application. In FIG. 4, this icon is indicated by the reference “Exit”. When the user points to an area around this icon, this can be interpreted by an intention to close the application. According to an embodiment the direction of the movement of the pointer can also be taken into account to interpret the intention of the user.

The aim of this implementation is to avoid an excessively large amount of tracking data being lost due to this closing. In this situation, it can be considered that the performance of the reception of the multimedia stream and of the interactivity of the human-machine interface are less important (since the user wishes to quit the application) than the transmission of the tracking data. The functional block 13 then transmits the tracking data stored in the buffer memory.

According to an embodiment, the transmission of tracking data can also be triggered when the buffer memory 14 is filled above a certain threshold.

According to an embodiment, the transmission of a block of tracking data can also be triggered when this block has been stored since too early a date (i.e. for a time that exceeds a given threshold).

Of course, this development is not limited to the examples and embodiment described and shown, but is defined by the claims. It is in particular able to undergo many variants accessible to those skilled in the art.

1. A method for supervising a multimedia stream reading terminal through a telecommunication network, including:
collecting tracking data intended for at least one tracking server connected to the telecommunication network,
storing the tracking data in a buffer memory of the reading terminal,
checking a resource load criterion of the reading terminal, and
transmitting at least a part of the tracking data to the at least one tracking server when the criterion is met.

2. The supervising method according to claim 1, wherein data of a first type and data of a second type are stored separately, and wherein the data of the first type are transmitted as a priority when the criterion is met.

3. The supervising method according to claim 2, wherein the data of the first type and the data of the second type are stored in two separate buffer memories.

4. The supervising method according to claim 1, wherein the resources comprise a load of the processing circuits of the terminal (10).

5. The supervising method according to claim 1, wherein the resources comprise a bandwidth to the telecommunications network (NET).

6. The supervising method according to claim 1, wherein the load criterion comprises the maintaining of a load below a given threshold for a given period.

7. The supervising method according to claim 1, including:
supervising the location of a pointer in a human-machine interface of the reading terminal, and
triggering the transmission of at least a part of the tracking data to the at least one tracking server when the location is in a given area.

8. A multimedia stream reading terminal comprising at least one interface to a telecommunication network and comprising a processor configured to execute the following:
collect tracking data intended for at least one tracking server connected to the telecommunications network,
store the tracking data in a buffer memory of the reading terminal,
check a resource load criterion of the reading terminal, and
transmitting at least a part of the tracking data to the at least one tracking server when the criterion is met.

9. A computer program implemented on a multimedia stream reading terminal, the program comprising program code instructions which, when the computer program is executed by a processor, executes the method according to claim 1.

10. A non-transitory computer-readable data medium on which has been stored at least a series of program code instructions to execute the method according to claim 1.
